(19) United States
(12) Patent Application Publication
(10) Pub. No.: US 2024/0379085 A1
(43) Pub. Date: Nov. 14, 2024

(54) FLOCKING SPONGE SOUND ABSORBER

(71) Applicant: HUIZHEN LIN, Guangzhou (CN)

(72) Inventor: HUIZHEN LIN, Guangzhou (CN)

(21) Appl. No.: 18/205,661

(22) Filed: Jun. 5, 2023

(30) Foreign Application Priority Data
May 12, 2023 (CN) 202310536440.8

(51) Int. Cl. G10K 11/162

(52) U.S. Cl. CPC G10K 11/162

(57) ABSTRACT

The present disclosure discloses a flocking sponge sound absorber, including a sponge bottom plate; a plurality of sound absorbing structures used for absorbing sound are arranged at a top of the sponge bottom plate at equal intervals; silencing channels are formed between the sound absorbing structures; each sound absorbing structure includes a sound absorbing main body; a top and four side surfaces of the sound absorbing main body are smeared with adhesive layers; and a flocking layer is electrostatically implanted into a surface of the sound absorbing main body by combining the adhesive layers. The flocking sponge sound absorber has relatively good sound absorbing effect, can well eliminate wind noise, and can be compressed and vacuumized to reduce a transportation volume and transportation costs. Meanwhile, the flocking sponge sound absorber can be quickly assembled in various occasions and has relatively high practicability.

### CROSS-REFERENCE TO RELATED APPLICATIONS

This application claims the benefit and priority of Chinese patent application No. 202310536440.8, filed on May 12, 2023, disclosure of which is hereby incorporated by reference in its entirety.

### TECHNICAL FIELD

The present disclosure belongs to the technical field of sponge, specifically to a flocking sponge sound absorber.

### BACKGROUND

At present, sound absorbing and soundproofing sponge on the market is made of an artificial polyester fiber material, which has a combination property of sound absorption, heat insulation, high-temperature resistance, impact resistance, light weight, and the like and is widely applied to producing products in the fields of building decorations, transportation vehicles and ships, and industrial sound absorption and thermal insulation.

However, with increasing demands for sound absorbing materials in aspects of transportation economy, fire safety, beautiful decoration, convenient installation, and the like, people have higher requirements for the sound absorbing materials in terms of economy, home applicability, fire resistance, and decoration.

Due to the nature, sound absorbing and soundproofing sponge made of polyurethane in the prior art is prone to oxidation reactions when exposed to the air, and its acoustic performance is limited, so that such sponge cannot well cover special modelings.

### SUMMARY

The present disclosure aims to provide a flocking sponge sound absorber to solve the problems mentioned in the background section.

In order to achieve the above objective, the present disclosure provides the following technical solution: A flocking sponge sound absorber includes a sponge bottom plate;

a plurality of sound absorbing structures used for absorbing sound are arranged at a top of the sponge bottom plate at equal intervals; silencing channels are formed between the sound absorbing structures;

each sound absorbing structure includes a sound absorbing main body; a top and four side surfaces of the sound absorbing main body are smeared with adhesive layers; and a flocking layer is electrostatically implanted into a surface of the sound absorbing main body by combining the adhesive layers.

Preferably, the sound absorbing main body is arranged at a top end of the sponge bottom plate, and the sponge bottom plate and the sound absorbing main body are both made of polyurethane.

Preferably, the adhesive layers are smeared by an electrostatic flocking machine according to a smearing thickness of 0.1 mm to 0.15 mm.

Preferably, a length of fluffs of the flocking layer is generally 0.3 mm to 0.8 mm.

Preferably, the sound absorbing main body has a groove-shaped, tower-shaped, prismatic, square, strip-type, conical, and hemispherical geometric modeling, and a geometric modeling formed by combining two or more of the above geometric modelings.

Preferably, the adhesive layer adopts an electrostatic flocking adhesive.

Technical effects and advantages of the present disclosure are as follows: According to the flocking sponge sound absorber, thanks to the arrangement of the sound absorbing structures, the flocking layers arranged on the sound absorbing main bodies are used to prevent the sound absorbing main bodies from being exposed to air and undergoing oxidization reactions, thereby eliminating the limitation on the acoustic performance. The flocking sponge sound absorber can better cover special modelings and has a relatively good sound absorbing effect.

Thanks to the plurality of sound absorbing structures arranged on the sponge bottom plate, the silencing channels formed between the plurality of sound absorbing structures are used to repeatedly bounce back sounds entering the silencing channels to absorb the sounds, thereby better eliminating wind noise. Furthermore, the geometric modeling of the sound absorber is modularized, so that the sound absorber can be compressed and vacuumized to reduce a transportation volume and transportation costs, and can be quickly assembled in various occasions.

### BRIEF DESCRIPTION OF DRAWINGS

FIG. 1 is a schematic structural diagram of the present disclosure;

FIG. 2 is a schematic diagram of an internal structure of the present disclosure; and

FIG. 3 is an enlarged diagram of a structure of a portion A of FIG. 2 of the present disclosure.

In the drawings: 1: sponge bottom plate; 2: sound absorbing structure; 201: sound absorbing main body; 202: adhesive layer; and 203: flocking layer.

### DETAILED DESCRIPTION

The technical solutions in the embodiments of the present disclosure will be described clearly and completely below in combination with the accompanying drawings of the embodiments of the present disclosure. Apparently, the described embodiments are only part of the embodiments of the present disclosure, not all embodiments. All other embodiments obtained by those of ordinary skill in the art based on the embodiments in the present disclosure without creative work shall fall within the protection scope of the present disclosure.

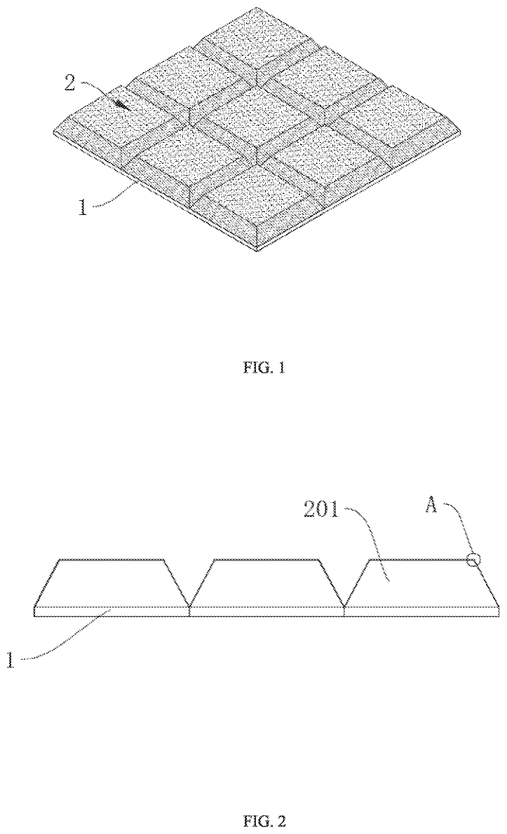

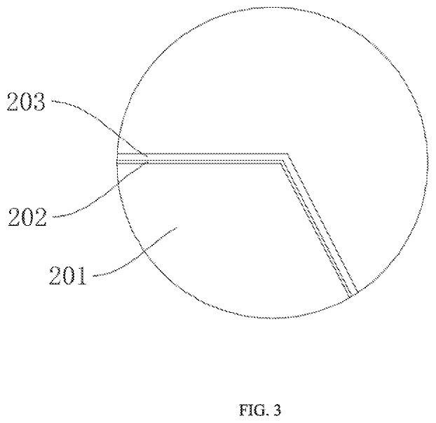

The present disclosure provides a flocking sponge sound absorber as shown in FIG. 1, FIG. 2, and FIG. 3. The flocking sponge sound absorber includes a sponge bottom plate 1. A plurality of sound absorbing structures 2 used for absorbing sound are arranged at a top of the sponge bottom plate 1 at equal intervals. Silencing channels are formed between the sound absorbing structures 2. The silencing channels formed between the plurality of sound absorbing structures 2 are used to repeatedly bounce back sounds entering the silencing channels to absorb the sounds, thereby better eliminating wind noise. Furthermore, the geometric modeling of the sound absorber is modularized, so that the sound absorber can be compressed and vacuumized to reduce a transportation volume and transportation costs, and can be quickly assembled in various occasions.

As shown in FIG. 1, FIG. 2, and FIG. 3, specifically, each sound absorbing structure 2 includes a sound absorbing main body 201. The sound absorbing main body 201 is arranged at a top end of the sponge bottom plate 1. The sponge bottom plate 1 and the sound absorbing main body 201 are both made of polyurethane.

The sound absorbing main body 201 has a groove-shaped, tower-shaped, prismatic, square, strip-type, conical, and hemispherical geometric modeling, and a geometric modeling formed by combining two or more of the above geometric modelings. A top and four side surfaces of the sound absorbing main body 201 are smeared with adhesive layers 202. Each adhesive layer 202 adopts an electrostatic flocking adhesive. The adhesive layers 202 are smeared by an electrostatic flocking machine according to a smearing thickness of 0.1 mm to 0.15 mm. Each flocking layer 203 is electrostatically implanted into a surface of each sound absorbing main body 201 by combining the adhesive layers 202. A length of fluffs of each flocking layer 203 is generally 0.3 mm to 0.8 mm. The flocking layers 203 arranged on the sound absorbing main bodies 201 are used to prevent the sound absorbing main bodies 201 from being exposed to air and undergoing oxidization reactions, thereby eliminating the limitation on the acoustic performance. The flocking sponge sound absorber can better cover special modelings and has a relatively good sound absorbing effect.

The working principle is as follows: According to the flocking sponge sound absorber, during use, the plurality of sound absorbing main bodies 201 arranged on the surface of the sponge bottom plate 1 and are delivered into the electrostatic flocking machine; the surfaces of the plurality of sound absorbing main bodies 201 are smeared with the adhesive through the electrostatic flocking machine, and the flocking layers 203 adhered on the adhesive layers 202 are electrostatically implanted into the surfaces of the sound absorbing main bodies 201 through the electrostatic flocking machine, thereby preventing the sound absorbing main bodies 201 from being exposed to air and undergoing oxidization reactions, and eliminating the limitation on the acoustic performance. The flocking sponge sound absorber can better cover special modelings and has a relatively good sound absorbing effect.

Finally, it should be noted that the above descriptions are only preferred embodiments of the present disclosure and are not intended to limit the present disclosure. Although the present disclosure has been described in detail with reference to the foregoing embodiments, those skilled in the art still can modify the technical solutions disclosed in the above-mentioned various embodiments, or make equivalent replacement to partial technical features. Any modifications, equivalent replacements, improvements and the like that are made without departing from the spirit and principle of the present disclosure shall all fall within the protection scope of the present disclosure.

What is claimed is:

1. A flocking sponge sound absorber, comprising a sponge bottom plate (1),
wherein a plurality of sound absorbing structures (2) used for absorbing sound are arranged at a top of the sponge bottom plate (1) at equal intervals; silencing channels are formed between the sound absorbing structures (2);
each sound absorbing structure (2) comprises a sound absorbing main body (201); a top and four side surfaces of the sound absorbing main body (201) are smeared with adhesive layers (202); and a flocking layer (203) is electrostatically implanted into a surface of the sound absorbing main body (201) by combining the adhesive layers (202).

2. The flocking sponge sound absorber according to claim 1, wherein the sound absorbing main body (201) is arranged at a top end of the sponge bottom plate (1); and the sponge bottom plate (1) and the sound absorbing main body (201) are both made of polyurethane.

3. The flocking sponge sound absorber according to claim 1, wherein the adhesive layers (202) are smeared by an electrostatic flocking machine according to a smearing thickness of 0.1 mm to 0.15 mm.

4. The flocking sponge sound absorber according to claim 1, wherein a length of fluffs of the flocking layer (203) is generally 0.3 mm to 0.8 mm.

5. The flocking sponge sound absorber according to claim 1, wherein the sound absorbing main body (201) has a groove-shaped, tower-shaped, prismatic, square, strip-type, conical, and hemispherical geometric modeling, and a geometric modeling formed by combining two or more of the above geometric modelings.

6. The flocking sponge sound absorber according to claim 1, wherein the adhesive layer (202) adopts an electrostatic flocking adhesive.
